(19) United States
(12) Patent Application Publication
(10) Pub. No.: US 2002/0170972 A1
(43) Pub. Date: Nov. 21, 2002

(54) Flash memory card

(76) Inventor: Moon Geun Kim, Anyang-shi (KR)

Correspondence Address: JACOBSON HOLMAN PLLC, 400 SEVENTH STREET N.W., SUITE 600, WASHINGTON, DC, 20004, US

(21) Appl. No.: 09/811,649

(22) Filed: Mar. 20, 2001

(51) Int. Cl. G06K 19/00; G06K 19/06

(52) U.S. Cl. 235/487; 235/492

(57) ABSTRACT

A flash memory card is related to enable digital data such as a music file, a picture file, a document data file, etc. to be memorized thereat, and particularly, to provide the erroneous erasure preventing function.

The flash memory card comprises a plurality of erroneous erasure preventing holes are perforated on the lower case, through holes are formed on a plurality of positions of the printed circuit board corresponding to the erroneous erasure preventing holes, conducting wires are connected between the memory and the contacting terminal portion passing by the through holes, circular grooves are formed on the inner surface of the upper case vertically corresponding to the erroneous erasure preventing holes and the through holes to indicate the cutting state of any one of the conducting wire for a user, thereby setting/releasing the erroneous erasure preventing.

### BACKGROUND OF THE INVENTION

The invention is related to a flash memory card including a casing in the form of a card, which enables digital data such as a music file, a picture file, a document data file, etc. to be memorized thereat, and particularly, to providing a flash memory card having the erroneous erasure preventing function.

### PRIOR ART

In general, a flash memory semiconductor can be repeatedly used in a manner to allow data to be recorded/written and erased, if necessary, as a computer chip with a read-only memory that retains its data when the power is turned off and that can be electronically erased and reprogrammed without being removed from the circuit board, variously used in an electronic appliance such as a facsimile, a camcorder, a mobile or cellular phone, etc. Furthermore, the flash memory semiconductor is packaged in a case in the form of a card to be used in a manner to be mounted in/removed out of the electronic appliance. The flash memory card allows the flash memory semiconductor to be freely moved or portable, thereby promoting the convenience of its use. For example, the flash memory card is adapted to a digital camera instead of a film used in a general camera. In these days, the flash memory card is used in an MP3 player in comply with an MPEG standard, especially MPEG-3, used in reproducing digitally compressed music files which contain a song or other audio data that is encoded using this standard.

The flash memory card is generally provided with a device for preventing the lost of data due to the erroneous erasing. There is a typical product of a flash memory card having a trademark “Memory Stick” released by the SONY company, which is subject to be switchable into the writeable and readable state according to the contacting point. In that case, the erroneous erasure preventing device mounted in the flash memory card has a disadvantage in that its manufacturing requires a relative higher cost. It is fearful that the data lost may happen due to the mistakenly operating of the switch.

Furthermore, the flash memory card commercially obtained as the trademark “Memory Stick” is designed to have ten electrical contacting points, which forces another controller of an integrated circuit chip to be mounted between ten contacting points and the flash memory in the flash memory card. Then, the controller is a higher expensive part that is a cause to raise the manufacturing cost of the flash memory card. It not only slows down the transmission speed of digital data, but also it restricts the scope in designing various appliance products using the flash memory card due to the consideration of the configuration of the controller.

An object of the invention is to provide a flash memory card including an erroneous erasure preventing device, in which the flash memory card comprises a plurality of conducting wires and a memory card drive or control unit for reading/writing data corresponding to an electrical signal voltage according to the connection state of the wires, and the erroneous erasure preventing device is mounted to enable the erroneous erasure preventing setting in the memory card drive in a simple configuration, thereby providing the erroneous erasure preventing function.

### SUMMARY OF THE INVENTION

According to the invention, a flash memory card comprises a printed circuit board including an integrated circuit memory mounted thereon and a contacting terminal portion including a plurality of electrical contact terminals connected to terminals of the integrated circuit memory in a one to one arrangement to be contacted with the read/write terminals of the memory to enable the inputting/outputting of data; upper and lower cases receiving the printed circuit board, in which a plurality of erroneous erasure preventing holes are perforated on the lower case, through holes are formed on a plurality of positions of the printed circuit board corresponding to the erroneous erasure preventing holes, conducting wires are connected between the memory and the contacting terminal portion passing by the through holes, circular grooves are formed on the inner surface of the upper case vertically corresponding to the erroneous erasure preventing holes and the through holes to indicate the cutting state of any one of the conducting wire for a user and a cutting-out portion formed to project the contacting terminal portion outward; a memory card drive connected to the integrated circuit memory through the contacting terminal portion and for detecting a voltage level inputted into its erroneous erasure preventing ports, judging the connecting state of the conducting wires based on the detected results, applying control signals to the corresponding ports of the integrated circuit memory to set/release the erroneous erasure preventing.

According to another embodiment of the invention, the flash memory card further comprises a control portion (Microprocessor Control Unit: MCU) mounted on the printed circuit board. The control portion judges whether the connecting state of conducting wires is maintained or not and controls the setting and releasing of the erroneous erasure preventing. For example, the control portion recognizes the connecting state of conducting wires according to the voltage level of any one of the conducting wires applied thereto and then controls the write enable (WE) and the write protect (WP) or the setting and releasing of the erroneous erasure preventing. It has a feature in that this embodiment enables the flash memory card to perform the erroneous erasure preventing function by itself irrelevant to the memory card drive.

### BRIEF DESCRIPTION OF THE DRAWINGS

The invention now will be described in detail with respect to the accompanying drawings, in which:

FIG. 1 is a perspective view illustrating an exterior appearance of a flash memory card adapted to the invention;

FIG. 2 is a perspective view illustrating the other side of the flash memory card of FIG. 1;

FIG. 3 is a cross-sectional view illustrating the configuration of the flash memory card cut along Line A-A′ of FIG. 2;

FIG. 4 is a cross-sectional view illustrating the configuration of the flash memory card cut along Line B-B′ of FIG. 2;

FIG. 5 is a plan view illustrating an exterior appearance of a printed circuit board according to the invention;

FIG. 6 is a schemetical block diagram illustrating an erroneous erasure preventing device having the connection of a plurality of conducting wires in an electrical circuit; and,

FIG. 7 is a schemetical block diagram illustrating another embodiment of an erroneous erasure preventing device according to the connection state of a plurality of conducting wires in an electrical circuit.

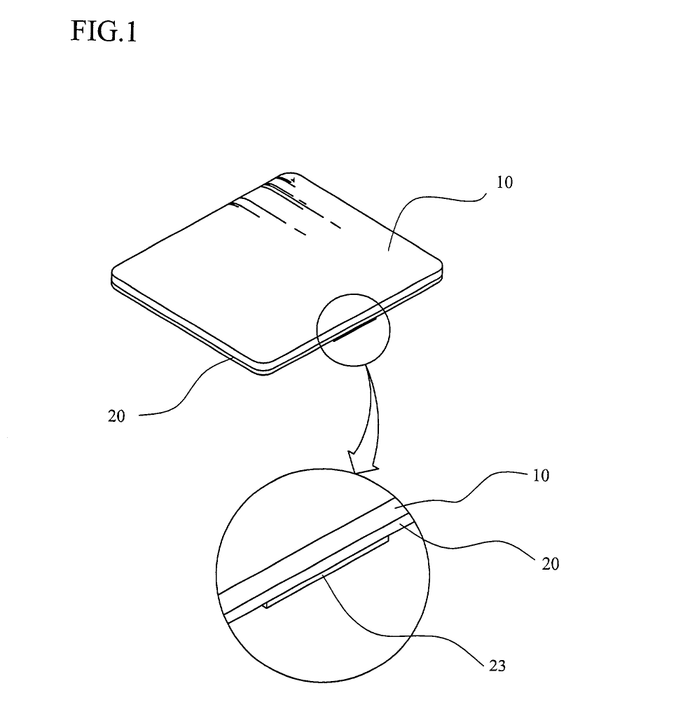

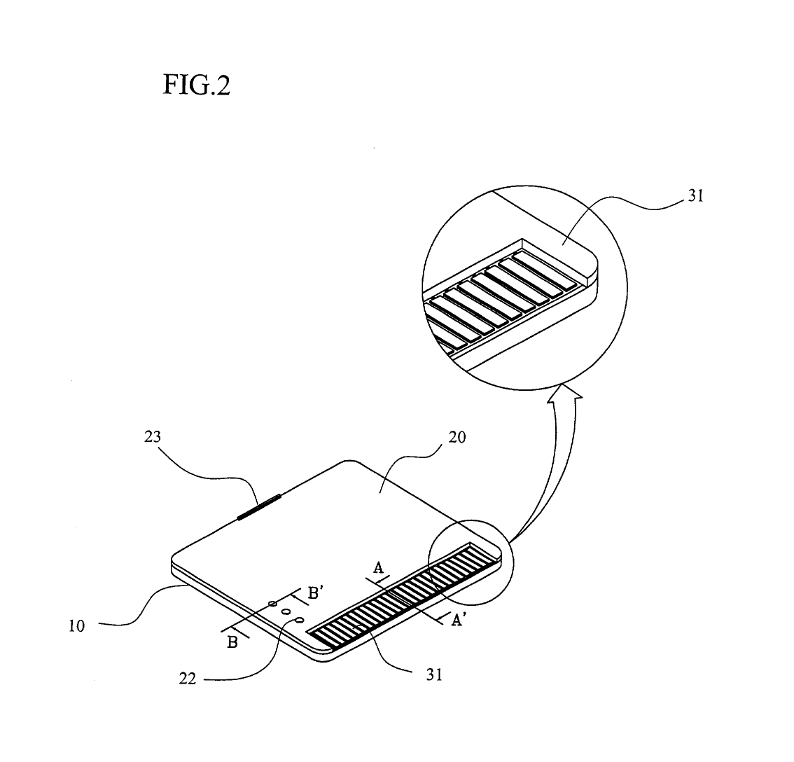

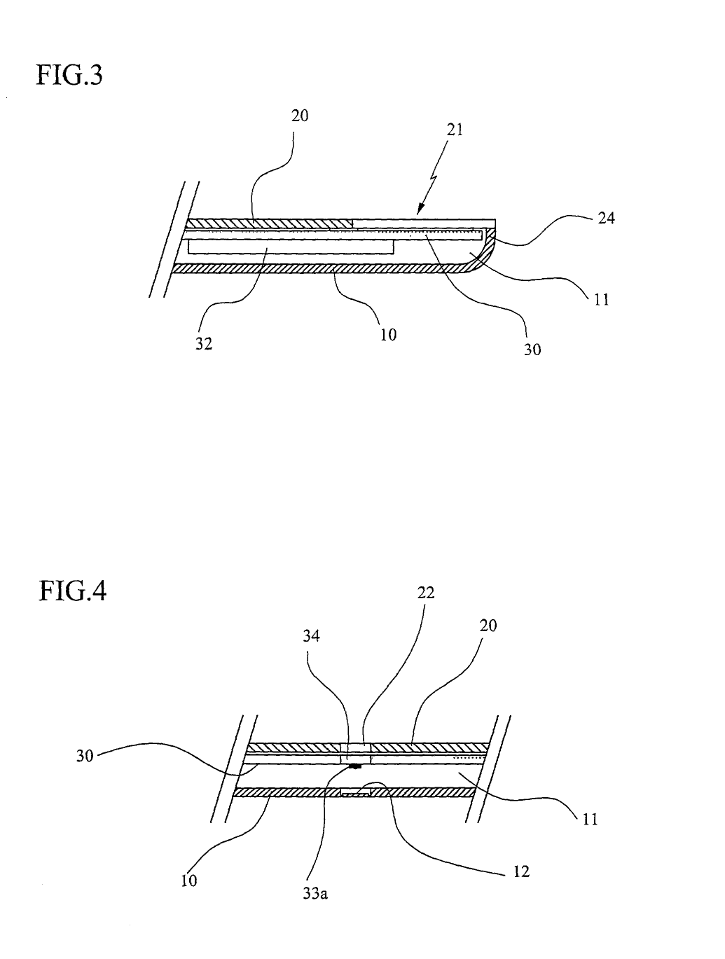

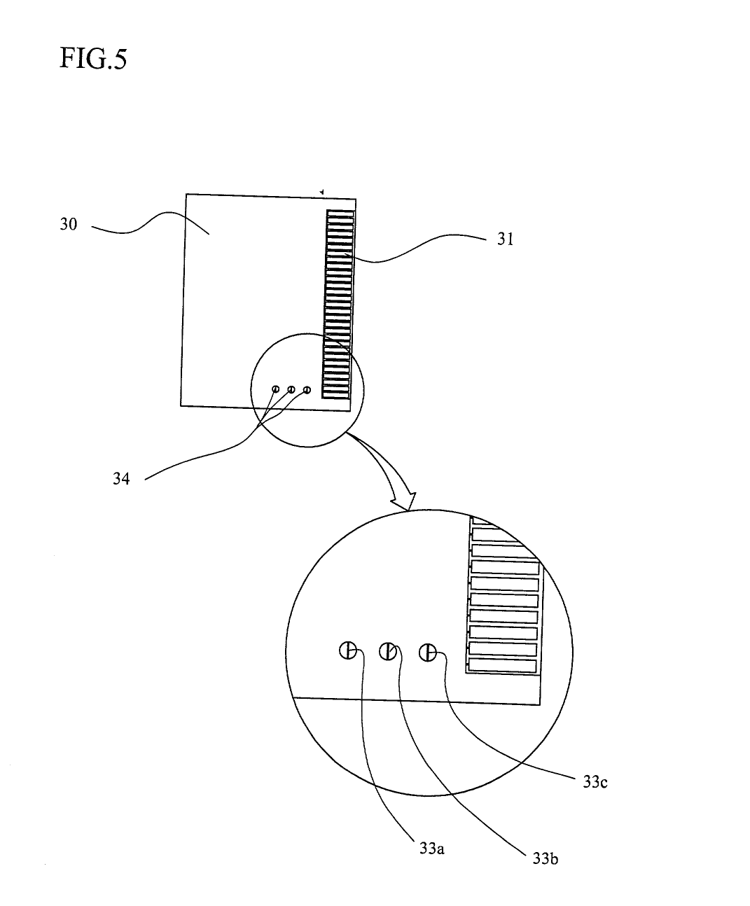

### DETAILED DESCRIPTION OF THE INVENTION

Referring to the drawings, a flash memory card comprises an upper case 10, a lower case 20 and a printed circuit board 30 packaged there between. The upper case 10 has a hollow space 11 to receive parts of a system therein. The lower case 20 includes a cutting-out portion 21 formed on one end of the bottom to project a contacting terminal portion 31 of the printed circuit board 30 outward therefrom, a predetermined number of erroneous erasure preventing holes 22 formed on the positions adjacent to the cutting-out portion corresponding to a previous designated number of the writing/erasing of data to enable a user to set the erroneous erasure prevention and a handling portion 23 and a handle portion 23 projected from the other end of the bottom to facilitate the flash memory card to be mounted in/removed from an appliance (not shown).

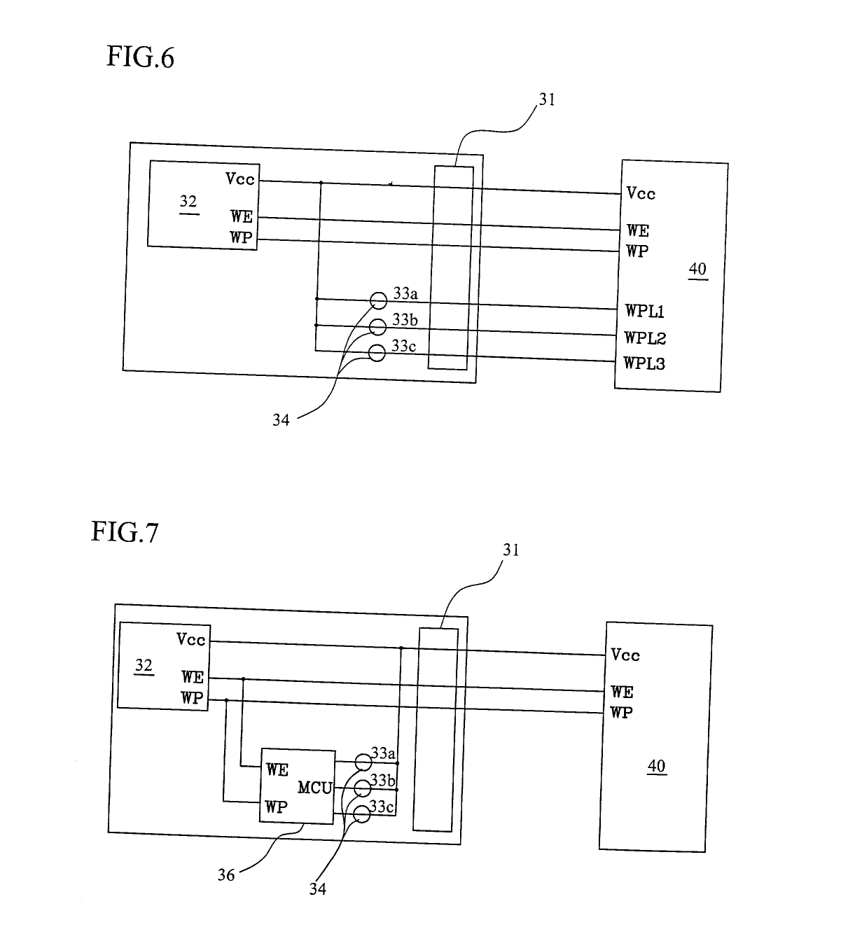

The printed circuit board 30 is fixed to the inner surface of the lower case 20, on which an integrated circuit memory 32 is mounted. The printed circuit board 30 includes a printed circuit formed to electrically connect the contacting terminal portion 31 of the integrated circuit memory 32 to a memory card drive 40. The printed circuit is formed to enable the data inputting and outputting of the integrated circuit memory 32 corresponding each of a plurality of terminals of the contacting terminal portion 31 to the terminals of the memory card drive 40 in a one to one arrangement. Herein, it is noted that the memory card drive 40 is shown at a block diagram format in FIGS. 6 and 7, but it means an interface circuit for the operating control of the integrated circuit memory 32 by the electronic appliance and is constituted as a part of the invention.

Furthermore, the printed circuit board 30 includes a plurality of through-holes 34 perforated on the positions corresponding to the erroneous erasure preventing holes 22. Conducting wires 33a, 33b, 33c are passed over the through holes 34 corresponding thereto, respectively, which are arranged on the printed circuit to be extended between the integrated circuit memory 32 and the terminals of the contacting terminal portion 31. Therefore, the ports of the memory card drive 40 are selectively connected to the ones of the integrated circuit memory 32 through the contacting terminal portion 31 according to the connecting state of the conducting wires 33a, 33b and 33c, thereby allowing a user to set the erroneous erasure preventing function of the integrated circuit memory 32 as described below in detail.

A circular groove 12 is formed on the inner surface of the upper case 10 to be vertically corresponded to the erroneous erasure preventing holes 22 along with the through holes 34 of the printed circuit board 30, which is formed as a weak portion to be easily perforated. Therefore, the circular groove 12 is perforated to indicate the erroneous erasure prevention for the user as described below in detail, while at least one of the conducting wires 33a, 33b and 33c is cut. A chamfer portion 24 is formed on the front end of the upper portion 10 to protect the contacting terminal portion 31.

The upper case 10 and the lower case 20 are moulded into a plastic material, which are coupled to each other on their comers or predetermined positions of their circumferences by an ultrasonic welding to form the flash memory card. The flash memory card is preferably made in a size of 54 mm×42.6 mm×2.8 mm which is half as large as a credit card. The erroneous erasure preventing holes 22 are formed in number, for example 3 according to the embodiment of the invention, on predetermined positions of the lower case 20. The erroneous erasure preventing holes 22 are also formed as a small hole having a diameter of 2 mm and arranged in a side by side to promote the convenience of the user. Similarly, the through holes 34, which the conducting wires 33a, 33b and 33c hang on, and the circular grooves the circular grooves 12 are formed to vertically correspond to the erroneous erasure preventing holes 22, respectively.

Therefore, the erroneous erasure preventing holes 22 is formed as a blind hole that is closed at the end. In order to set/release the erroneous erasure preventing or enabling/protecting the writing of data, at least one of the conducting wires 33a, 33b and 33c are selectively cut off by means of a driver, etc. through the erroneous erasure preventing holes 22, while the weak portion of the circular grooves 22 vertically corresponding to the conducting wires cut are broken down. In that time, the erroneous erasure preventing holes 22 are extended to the upper case 10 to allow the user to confirm on how many erroneous erasure preventing holes have been used. The conducting wires 33a, 33b and 33c are a soft and thin metal wire made of a copper or an alloy including the copper, which is mounted in the form of a jumper on the printed circuit board 30.

As described above, the erroneous erasure preventing device comprises the erroneous erasure preventing holes 22 formed on the lower case 20, the through holes 34 perforated on the printed circuit board 30, the conducting wires 33a, 33b and 33c passing over the through holes 34, respectively, and the circular grooves 12 formed as a weak portion on the inner surface of the upper case 10.

On the other hand, table 1 shows an example of the integrated circuit memory 32 that has ports Nos. 1 to 26 corresponding to each of terminal of the contacting terminal portion 31. Three ports Nos. 23, 24 and 25 of these ports are respectively connected to the terminals of the contacting terminal portion 31 through the conducting wires 33a, 33b and 33c and the remainders are directly connected to the terminals of the contacting terminal portion 31 in a one to one arrangement. Herein, it is noted that the integrated circuit memory 32 can perform the inputting/outputting of data without any aid of a separate integrated circuit controller. On the contrary, if the controller is adapted to the flash memory card, it increases the manufacturing cost, reduces the inputting/outputting speed of data and causes a trouble with the design that the architecture of the controller is compatible with the integrated circuit memory 32 to be used. The Table 1 is as blows:

TABLE 1

| | CONTACTING | |
|---|---|---|
| PORT | TERMINAL | |
| NUMBER | NAME | FUNCTION EXPLANATION |
| 1 | Vcc | DC POWER SUPPLY |
| 2 | I/O 1 | DATA INPUT/OUTPUT |
| 3 | I/O 2 | DATA INPUT/OUTPUT |
| 4 | I/O 3 | DATA INPUT/OUTPUT |
| 5 | I/O 4 | DATA INPUT/OUTPUT |
| 6 | I/O 5 | DATA INPUT/OUTPUT |
| 7 | I/O 6 | DATA INPUT/OUTPUT |
| 8 | I/O 7 | DATA INPUT/OUTPUT |
| 9 | I/O 8 | DATA INPUT/OUTPUT |
| 10 | CE | #1 CHIP ENABLE |
| 11 | CE | #2 CHIP ENABLE |
| 12 | NC | NO CONNECTION |
| 13 | NC | NO CONNECTION |
| 14 | R/B | CHIPS READ/BUSY SIGNAL |
| 15 | RE | READ ENABLE |
| 16 | OPTION | |
| 17 | WP | WRITE PROTECT |
| 18 | WE | WRITE ENABLE |
| 19 | ALE | ALL CHIPS ADDRESS |
| | | LATCH ENABLE |
| 20 | CLE | ALL CHIPS COMMAND |
| | | LATCH ENABLE |
| 21 | VccQ | OUTPUT BUFFER POWER |
| 22 | NC | NO CONNECTION |
| 23 | WPL1 | WRITE PROTECT LEAD1 |
| 24 | WPL2 | WRITE PROTECT LEAD2 |
| 25 | WPL3 | WRITE PROTECT LEAD3 |
| 26 | Vss | Vss (DEVICE ENABLE) |

As show in Table 1, the integrated circuit memory 22 has ports of Vcc for supplying DC power. I/O 1 to 8 for the inputting/outputting of data, CE, RE, WE, WP, Vss, etc., the detailed function explanation of which is omitted due to the known technology.

As shown in FIG. 6, the electrical connection relationships of the conducting wires 33a, 33b and 33c in the printed circuit are shown. The conducting wires 33a, 33b and 33c are connected at one ends to erroneous erasure preventing setting ports or write protect lead ports WPL1, WPL2 and WPL3 of the memory card driver 40 through the corresponding terminals of the contacting terminal portion 31, respectively, and at their other ends to the power port Vcc at the same time.

Therefore, the memory card drive 40 recognizes the voltage level of the erroneous erasure preventing setting ports WPL1, WPL2 and WPL3 to determine whether the conducting wires 33a, 33b and 33c are cut off. Then, according to the connection state of the conducting wires 33a, 33b and 33c, the memory card drive 40 applies predetermined control signals from its erroneous erasure preventing setting control ports WE and WP to the erroneous erasure preventing setting control ports WE and WP of the integrated circuit memory 32, thereby controlling the erroneous erasure preventing setting/releasing of the flash memory card.

In other words, in order to set the erroneous erasure preventing of the overlapping or overwriting of data on a file stored at the integrated circuit memory 32, any one of the conducting wires 33a, 33b and 33c is cut in a manner to push means such as a driver into the corresponding erroneous erasure preventing holes 22 and the corresponding weak portion of the circular grooves 12 is broken down. Like this, if any one of the conducting wires 33a, 33b and 33c is cut, the power voltage respectively supplied through the conducting wires 33a, 33b and 33c to any one of the erroneous erasure preventing setting ports WPL1, WPL2 and WPL3 is cut off. Therefore, the memory card drive 40 identifies that any one of the conducting wires 33a, 33b and 33c was cut and applies the writing prohibit signals or the write protect signals from its port WP to the port WP of the integrated circuit memory 32 to protect data stored at the integrated circuit memory 32.

For example, if the user cuts any one of the conducting wires 33a, 33b and 33c, the power supplied to the erroneous erasure preventing port or the write protect lead WPL1 is cut off. Then, the memory card driver 40 recognizes the cutting-off state of the conducting wires 33a to set the erroneous erasure preventing of the integrated circuit memory 32.

Thereafter, if the flash memory card that the erroneous erasure preventing has previously been set is intended to recover the writeable or recordable state, any one of the other two erroneous erasure preventing holes 33b and 33c is cut. At that time, the memory card driver 40 recognizes the cutting-off state to apply the writeable signal or write enable signals from its port WE to the port WE of the integrated circuit memory 32, thereby releasing the erroneous erasure preventing setting of the integrated circuit memory 32.

Also, in such like writeable state, if the conducting wire 33c is cut, the memory card driver 40 recognizes the cutting-off state of the conducting wires 33c to apply the writing prohibit signals from its port WP to the port WP of the integrated circuit memory 32, thereby setting the erroneous erasure preventing of the integrated circuit memory 32.

Therefore, the memory card drive 40 detects the voltage level of its respective ports WPL1, WPL2 and WPL3. If add number of ports are turned into the low voltage level, the memory card drive 40 forces the integrated circuit memory 32 to be set at the erroneous erasure preventing function so as to prohibit the write of data there into. If even number of ports are turned into the low voltage level, the memory card drive 40 forces the integrated circuit memory 32 to be released from the erroneous erasure preventing function so as to enable the write of data there into. Herein, it is noted that even number includes “0”, which means the writeable state at an initial stage.

Furthermore, as described above, as at least one of the circular grooves 12 is broken down, the erroneous erasure preventing holes 22 are vertically associated with the holes that form the corresponding circular groove 12. Therefore, the holes allow the user to identify whether the flash memory card is now set at the erroneous erasure preventing state or at the state that the data can be written there into.

Table 2 shows states of the erroneous erasure preventing setting according to the complete piercing state of the erroneous erasure preventing holes 22.

TABLE 2

| | THE OPERATING | | | | |
|---|---|---|---|---|---|
| | OF ERRONEOUS | | | | |
| | ERASURE PRE- | HOLE | HOLE | HOLE | STATE |
| | VENTING DEVICE | 1 | 2 | 3 | EXPLANATION |
| 1. | ANY HOLE IS | ◯ | ◯ | ◯ | WRITE |
| | KEPT AT AN | | | | ENABLE (WE) |
| | ORIGINAL STATE | | | | |
| | THAT A | | | | |
| | MEMORY IS | | | | |
| | REPEATEDLY | | | | |
| | WRITTEN/ | | | | |
| | ERASED. | | | | |
| 2. | ANY ONE OF | ● | ◯ | ◯ | WRITE |
| | THREE HOLES IS | | | | PROTECT (WP) |
| | PIECED FOR PRO- | ◯ | ● | ◯ | WRITE |
| | TECTING FILES | | | | PROTECT (WP) |
| | WRITTEN INTO | ◯ | ◯ | ● | WRITE |
| | THE MEMORY. | | | | PROTECT (WP) |
| 3. | ANOTHER ONE | ● | ● | ◯ | WRITE |
| | OF TWO HOLES | | | | ENABLE (WE) |
| | IS PIECED FOR | ◯ | ● | ● | WRITE |
| | REWRITING | | | | ENABLE (WE) |
| | DATA INTO THE | ● | ◯ | ● | WRITE |
| | MEMORY THAT | | | | ENABLE (WE) |
| | HAS BEEN | | | | |
| | PROTECTED. | | | | |
| 4. | THE REMAINING | ● | ● | ● | WRITE |
| | HOLE IS PIECED | | | | PROTECT (WP) |
| | FOR PRO- | | | | |
| | TECTING THE | | | | |
| | WRITTEN FILES, | | | | |
| | AGAIN. | | | | |

It is apparent that the invention adapts three erroneous erasure preventing holes, but can be provided with 5 or 7 holes more than 3 holes or numerous holes, if necessary. Particularly, it is not preferable if the erroneous erasure preventing hole is formed as the even numbers such as 4, 6, etc., because the erroneous erasure preventing device aims to prohibit the overlap write of data into the memory. In other words, cutting any one of the conducting wires 33a, 33b and 33c corresponding to the erroneous erasure preventing holes 22 is not important, but it is noted that the even or odd number of the conducting wire cuts indicates the setting or releasing of the erroneous erasure preventing.

In light of our much experience, as far as a cassette tape is concerned, it is found that most of the tapes commercially obtained are used to be recorded only one time rather than being overlapped for another record a few times. The repetitive used tape is almost 1% of the total number of the tape to be manufactured. Therefore, the three erroneous erasure prevent holes 22 are sufficient for use of the flash memory card.

Referring to FIG. 7, another embodiment is shown, in which the erroneous erasure preventing setting can be performed independent of a memory card drive 40. According to this embodiment, a flash memory card further comprises a control portion (Microprocessor Control Unit: MCU) 36 mounted on a printed circuit board 30. The control portion 36 judges whether the connecting state of conducting wires 33a, 33b and 33c is maintained or not and controls the setting and releasing of the erroneous erasure preventing. For example, the control portion 36 recognizes the connecting state of conducting wires 33a, 33b and 33c according to the voltage level of any one of the conducting wires 33a, 33b and 33c applied thereto and then controls the write enable (WE) and the write protect (WP) or the setting and releasing of the erroneous erasure preventing. It has a feature in that this embodiment enables the flash memory card to perform the erroneous erasure preventing function by itself irrelevant to the memory card drive.

As described above, according to the invention, a contacting terminal portion formed on a printed circuit board can be provided with a plurality of terminals enough to correspond to the number of a flash memory in a one to one arrangement. Its manufacturing becomes cheaper and the inputting/outputting speed of data is advanced, because a separate integrated circuit control chip is not required. If an appliance using a flash memory card is intended to be manufactured, it is easy to design the appliance in a manner to mount a flash memory card there into.

Also, the size of the flash memory card is very small half as large as a credit card, so that two flash memory chips can be mounted on the printed circuit board, thereby increasing the capacity of the flash memory twice.

What is claimed is:

1. A flash memory card comprising:
a printed circuit board including an integrated circuit memory mounted thereon and a contacting terminal portion including a plurality of electrical contact terminals connected to terminals of the integrated circuit memory in a one to one arrangement to be contacted with the read/write terminals of the memory to enable the inputting/outputting of data;
upper and lower cases receiving the printed circuit board, in which a plurality of erroneous erasure preventing holes are perforated on the lower case, through holes are formed on a plurality of positions of the printed circuit board corresponding to the erroneous erasure preventing holes, conducting wires are connected between the memory and the contacting terminal portion passing by the through holes, circular grooves are formed on the inner surface of the upper case vertically corresponding to the erroneous erasure preventing holes and the through holes to indicate the cutting state of any one of the conducting wire for a user and a cutting-out portion formed to project the contacting terminal portion outward; and
a memory card drive connected to the integrated circuit memory through the contacting terminal portion and for detecting a voltage level inputted into its erroneous erasure preventing ports, judging the connecting state of the conducting wires based on the detected results, applying control signals to the corresponding ports of the integrated circuit memory to set/release the erroneous erasure preventing.

2. The flash memory card as claimed in claim 1, wherein:
the flash memory card further comprises a control portion mounted on the printed circuit board, in which the control portion judges whether the connecting state of conducting wires is maintained or not and controls the setting and releasing of the erroneous erasure preventing.

3. The flash memory card as claimed in claim 1, wherein:
the conducting wire includes “0” in its total number to be not cut, so that if the number cut is even, it indicates the writeable state of the integrated circuit memory, and on the contrary, if the number cut is odd, it indicates the erroneous erasure preventing setting.

4. The flash memory card as claimed in claim 1, wherein:
the number of the erroneous erasure preventing hole, the through hole of the printed circuit board and the circular groove of the upper case corresponding to the erroneous erasure preventing hole and the conducting wire hanging on the through hole is odd.

5. The flash memory card as claimed in claim 1, wherein:
the circular groove is formed as a weak portion.

6. The flash memory card as claimed in claim 1, wherein:
the erroneous erasure preventing hole, the through hole, the circular groove of the upper case and the conducting wire are constituted as an erroneous erasure preventing device.

7. The flash memory card as claimed in claim 1, wherein:
The memory flash card further comprises at least two integrated circuit memories.
